(19) United States
(12) Patent Application Publication
(10) Pub. No.: US 2025/0094451 A1
(43) Pub. Date: Mar. 20, 2025

(54) GREEN KNOWLEDGE RECOMMENDATION MATHOD BASED ON CHARACTERISTIC SIMILARITY AND USERDEMANDS, ELECTRONIC DEVICE AND COMPUTER READABLE STORAGE MEDIUM THEREOF

(71) Applicant: HEFEI UNIVERSITY OF TECHNOLOGY, Hefei (CN)

(72) Inventors: Qingdi Ke, Hefei (CN); Zhen Zhang, Hefei (CN); Zisheng Li, Hefei (CN); Lei Zhang, Hefei (CN)

(21) Appl. No.: 18/964,413

(22) Filed: Nov. 30, 2024

Related U.S. Application Data
(63) Continuation of application No. PCT/CN2023/118564, filed on Sep. 13, 2023.

(30) Foreign Application Priority Data
Feb. 13, 2023 (CN) 202310103329.X

(51) Int. Cl. G06F 16/28; G06F 16/21; G06F 16/2457; G06F 40/30; G06N 5/022

(52) U.S. Cl. CPC G06F 16/285; G06F 16/213; G06F 16/2457; G06N 5/022; G06F 40/30

(57) ABSTRACT

The present invention discloses a green knowledge recommendation method based on characteristic similarity and user demands, an electronic device and a computer readable storage medium thereof. The method includes: obtaining a current-search text e and a historical-search-texts set Eᵤ both from a user; constructing a topics dictionary and a subtopics dictionary according to a green knowledge base, and decomposing the e and the Eᵤ on the basis of semantic decomposition; picking words in a text-vector set and a valid-text set that about two dictionaries; finding the corresponding knowledge according to user satisfaction. The invention enables users to quickly find the required content through templating, thus avoiding users' meaningless search, improving search efficiency, and reducing the loss of useless time.

### FIELD OF THE INVENTION

The present invention relates to green knowledge recommendation methods, and more particularly to a green knowledge recommendation method based on characteristic similarity and user demands, an electronic device and a computer readable storage medium thereof.

### BACKGROUND OF THE INVENTION

In the green knowledge base, the traditional way for users to search for the desired knowledge is not accurate and the search time is too slow. Because users in the search process is often very broad but not accurate. The traditional way to respond to a user's search is to give a search result that is only large enough, rather than trying to determine how to reduce uncertainty in the user's broad knowledge. Traditional methods only give a broad range of results and let the user to slowly search for themselves, thereby reducing what is unnecessary knowledge. Such a search method is too slow, and the search results are not accurate enough to meet the needs of users.

### SUMMARY OF THE INVENTION

The object of the present invention is to provide a green knowledge recommendation method based on characteristic similarity and user demands to solve the problem that the search results are not accurate enough to meet the needs of users. The green knowledge recommendation method acts as a template-based method and allows users to quickly find what they need, so as to avoid users' meaningless search, improve the search efficiency, and reduce the loss of useless time.

It is adopted by the present invention to realize with the following technical scheme.

A green knowledge recommendation method based on characteristic similarity and user demands includes following steps 1˜4.

Step 1, obtain a current-search text e and a historical-search-texts set Eᵤ both from a user u, Eᵤ={e_{1,u}, e_{2,u} . . . , eₙ_{₁}_{,u}, . . . , E_{N}_{₁}_{,u}}. Wherein, the e_{n1,u} represents the n₁ th historical-search text, 1≤n₁≤N₁; the N₁ represents the total number of historical-search texts.

Step 2, construct a topics dictionary and a subtopics dictionary, and decompose the current-search text e and the historical-search-texts set Eᵤ on the basis of semantic decomposition. The step 2 includes steps 2.1˜2.6.

Step 2.1, construct a topics dictionary X of a green knowledge base, X={x₁, x₂, . . . , xₙ₂, . . . . x_{N2}}. Wherein the xₙ₂ represents the n₂ th topics, the N₂ represents the total number of topics in the dictionary X.

Construct a subtopics dictionary Y of the green knowledge base, Y={y₁, y₂, . . . , yₙ₃, . . . , y_{N3}}. Wherein the yₙ₃ represents the n₃ th subtopics, the N₃ represents the total number of subtopics in the dictionary Y.

Construct a daily-expressions dictionary C of a set of users, C={c₁, c₂, . . . , cₙ₄, . . . , c_{N4}}. Wherein the cₙ₄ represents the n₄ th daily expression, the N₄ represents the total number of daily expressions in the dictionary C.

Step 2.2, decompose e and e_{n1,u} according to dictionaries X, Y, C to obtain two text-vector sets wₑ and wₙ₁ correspondingly. The wₑ is about the current-search text e, wₑ={w₁^{e}, w₂^{e}, . . . , wᵢ_{ₑ}^{e}, . . . , wᵢ_{ₑ}^{e}}. The wₙ₁ is about the n₁ th historical-search text e_{n1,u},

$${w}_{{n}_{1}} = \{ {w}_{1}^{{n}_{1}} , {w}_{2}^{{n}_{1}} , … , {w}_{{i}_{{n}_{1}}}^{{n}_{1}} , … , {w}_{{I}_{{n}_{1}}}^{{n}_{1}} \} .$$

Wherein the wᵢ_{ₑ}^{e} represents the iₑ th word of the current-search text e; the Iₑ represents the total number of words in the current-search text e; the

$${w}_{{i}_{{n}_{1}}}^{{n}_{1}}$$

represents the i th word or the n₁ the historical-search text e_{n1,u}; the Iₙ_{₁} represents the total number of words in the n₁ th historical-search text e_{n1,u}.

Define ti, being the label of the wᵢ_{ₑ}^{e}. If the tᵢ_{ₑ}^{e} belongs to the dictionary X, define wᵢ_{ₑ}^{e}∈X; if the tᵢ_{ₑ}^{e} belongs to the dictionary Y, define wᵢ_{ₑ}^{e}∈Y; if the tᵢ_{ₑ}^{e} belongs to the dictionary C, define wᵢ_{ₑ}^{e}∈C; otherwise define wᵢ_{ₑ}^{e}∈Ø.

Define tᵢⁿ^{₁} being the label of

$${w}_{{i}_{{n}_{1}}}^{{n}_{1}} .$$

If the tᵢⁿ^{₁} belongs to the dictionary X, define

$${w}_{{i}_{{n}_{1}}}^{{n}_{1}} ∈ X ;$$

if it the tᵢⁿ^{₁} belongs to the dictionary Y, define

$${w}_{{i}_{{n}_{1}}}^{{n}_{1}} ∈ {Y}_{;}$$

if the tᵢⁿ^{₁} belongs to the dictionary C, define

$${w}_{{i}_{{n}_{1}}}^{{n}_{1}} ∈ C ,$$

otherwise define

$${w}_{{i}_{{n}_{1}}}^{{n}_{1}} ∈ ∅ .$$

Step 2.3, obtain the weight Lᵢⁿ^{₁} of the i th word

$${w}_{{i}_{{n}_{1}}}^{{n}_{1}}$$

by the formula (1).

$${L}_{i}^{{n}_{1}} = \{ \begin{matrix}{δ}_{1} , & if {t}_{i}^{{n}_{1}} ∈ X \\ {δ}_{2} , & if {t}_{i}^{{n}_{1}} ∈ Y \\ 0 , & if {t}_{i}^{{n}_{1}} ∈ C ⋃ \{ ∅ \}\end{matrix} \qquad ( 1 )$$

In the formula, the δ₁ represents the first weight, the δ₂ represents the second weight, and 0<δ₂<δ₁<1.

Step 2.4, obtain the weight Lᵢ_{ₑ}^{e}, of the iₑ th word wᵢ_{ₑ}^{e} by the same way of step 2.3.

Step 2.5, obtain the similarity

$$g ( {w}_{{i}_{e}}^{e} , {w}_{{i}_{{n}_{1}}}^{{n}_{1}} )$$

between the wᵢ_{ₑ}^{e} and the

$${w}_{{i}_{{n}_{1}}}^{{n}_{1}}$$

by the formula (2).

$$g ( {w}_{{i}_{e}}^{e} , {w}_{{i}_{{n}_{1}}}^{{n}_{1}} ) = \frac{( {\sum }_{{i}_{e} = 1}^{{I}_{e}} {w}_{{i}_{e}}^{e} {L}_{{i}_{e}}^{e} ) ( {\sum }_{{i}_{{n}_{1}} = 1}^{{I}_{{n}_{1}}} {w}_{{i}_{{n}_{1}}}^{{}_{{n}_{1}}} {L}_{{i}_{{n}_{1}}}^{{n}_{1}} )}{\begin{matrix}{‖ {\sum }_{{i}_{e} = 1}^{{I}_{e}} {w}_{{i}_{e}}^{e} {L}_{{i}_{e}}^{e} ‖}^{2} {‖ {\sum }_{{i}_{{n}_{1}} = 1}^{{I}_{{n}_{1}}} {w}_{{i}_{{n}_{1}}}^{{n}_{1}} {L}_{{i}_{{n}_{1}}}^{{n}_{1}} ‖}^{2} - \\ ( {\sum }_{{i}_{e} = 1}^{{I}_{e}} {w}_{{i}_{e}}^{e} {L}_{{i}_{e}}^{e} ) ( {\sum }_{{i}_{{n}_{1}} = 1}^{{I}_{{n}_{1}}} {w}_{{i}_{{n}_{1}}}^{{n}_{1}} {L}_{{i}_{{n}_{1}}}^{{n}_{1}} )\end{matrix}} \qquad ( 2 )$$

Step 2.6, obtain the similarities between each of the two words respectively from two text-vector sets wₑ and wₙ₁ by the same way of step 2.5. Collect words with the highest similarity to be a candidate-words set in which one candidate word would be select to be the n₁ th word of the wₑ. A valid-text set Vᵢ_{ₑ}^{e} is defined by all candidate-words sets, Vᵢ_{ₑ}^{e}={v_{1,i}_{ₑ}^{e}, v_{2,i}_{ₑ}^{e}, . . . v_{p,i}_{ₑ}^{e}, . . . , v_{P,i}_{ₑ}^{e}}. Wherein the v_{P,i}_{ₑ}^{e} represents the p th candidate word of the iₑ th word wᵢ_{ₑ}^{e}, the p represents the total number of candidate words.

Step 3, according to the weight, pick words in the wₑ and the Vᵢ_{ₑ}^{e} that belong to the two dictionaries X and Y. The step 3 includes steps 3.1˜3.6.

Step 3.1, pick words in the wₑ that belong to the dictionary X.

When wᵢ_{ₑ}^{e}Lᵢ_{ₑ}ⁿ^{₁}=δ₁, xᵢ_{ₑ}^{e} is defined to mean the words corresponding to the wᵢ_{ₑ}^{e} and is also from the dictionary X. The first words set is defined by many xᵢ_{ₑ}^{e} accordingly, and the Lᵢ_{ₑ}ⁿ^{₁} is the weight of the wᵢ_{ₑ}^{e}.

Step 3.2, pick words in the Vᵢ_{ₑ}^{e} that belong to the dictionary X.

When v_{p,i}_{ₑ}^{e}L_{p,i}_{ₑ}^{e}=δ₁, x_{p,i}_{ₑ}^{e} is defined to mean the words corresponding to the v_{p,i}_{ₑ}^{e} and is also from the dictionary X. The second words set is defined by many Vᵢ_{ₑ}^{e} accordingly, and the L_{p,i}_{ₑ}^{e} is the weight of the v_{p,i}_{ₑ}^{e}.

Step 3.3, a large-subject terms set Z is defined by the first words set and the second words set, Z={z₁^{X}, z₂^{X}, . . . , zₙ_{₅}^{X}, . . . , z_{N}_{₅}^{X}}.

Wherein the zₙ_{₅}^{X} represents the n₅ th large-subject term, 1≤n₅≤N₅, and the N₅ represents the total number of large-subject terms.

Step 3.4, pick words in the wₑ that belong to the dictionary Y. When wᵢ_{ₑ}^{e}Lᵢⁿ^{₁}=δ₁, γᵢ_{ₑ}^{e} is defined to mean the words corresponding to the wᵢ_{ₑ}^{e} and is also from the dictionary Y.

Step 3.5, pick words in the Vᵢ_{ₑ}^{e} that belong to the dictionary Y; when Lᵢⁿ^{₁}=δ₁, γᵢ^{valid} is defined to mean the words corresponding to the Vᵢ_{ₑ}^{e} and is also from the dictionary Y.

Step 3.6, a minor-subject terms set V is defined by the wₑ and the Vᵢ_{ₑ}^{e}, V={v₁^{Y}, v₂^{Y}, . . . , vₙ_{₆}^{Y}, . . . , v_{N}_{₆}^{Y}}. Wherein the vy, represents the n₆ th minor-subject term, 1≤n₆≤N₆, and the N₆ represents the total number of minor-subject terms.

Step 4, find the corresponding knowledge according to user satisfaction. The step 4 includes steps 4.1˜4.6.

Step 4.1, acquire a knowledge a to be identified, and calculate the frequency of each of the word appearing in the knowledge a after semantic decomposition under the dictionary X and the minor-subject terms set V,

$$\{ {s}_{{x}_{1}}^{a} , … {s}_{{x}_{{n}_{2}}}^{a} , … {s}_{{x}_{{N}_{2}}}^{a} , {t}_{{v}_{1}^{Y}}^{a} , … , {t}_{{v}_{{n}_{6}}^{Y}}^{a} , … , {t}_{{v}_{{N}_{6}}^{Y}}^{a} \} .$$

### Wherein the

$${s}_{{x}_{{n}_{2}}}^{a}$$

represents the frequency of the n₂ th topic xₙ_{₂} appearing in the knowledge a

$$0 \leq {s}_{{x}_{{n}_{2}}}^{a} \leq 1 ;$$

and the

$${t}_{{v}_{{N}_{6}}^{Y}}^{a}$$

represents the frequency of the n₆ th subtopic vₙ_{₆}^{Y} appearing in the knowledge a, 0≤

$${t}_{{v}_{{n}_{6}}^{Y}}^{a} \leq 1 .$$

Step 4.2, assigns a value to each of the word in the minor-subject terms set V, and a weighting function H(vₙ_{₆}^{Y}) of words in minor-subject terms set V is defined as formula (3).

$$H ( {v}_{{n}_{6}}^{{}_{Y}} ) = \frac{{v}_{{n}_{6}}^{{}_{Y}}}{{\sum }_{{n}_{6} = 1}^{{N}_{6}} {v}_{{n}_{6}}^{{}_{Y}}} \qquad ( 3 )$$

Step 4.3, a user-demand degree function Q(vₙ_{₆}^{Y}) is defined as formula (4).

$$Q ( {v}_{{n}_{6}}^{Y} ) = H ( {v}_{{n}_{6}}^{Y} ) k \qquad ( 4 )$$

In the formula, the K represents users' satisfaction, kϵ(0,100%).

Step 4.4, get a topic xᵤₛₑᵣ required by the user in the topics dictionary X, and calculate the closing degree d₁^{a} between the topic xᵤₛₑᵣ and the knowledge a, d₁^{a}=1−sₓ_{ᵤₛₑᵣ}^{a}. Wherein the st represents the frequency of the topic xᵤₛₑᵣ appearing in the knowledge a.

Step 4.5, get the user's demand for each of the minor-subject term in the minor-subject terms set V, and calculate the user's closing degree dg to all of the minor-subject terms,

$${d}_{2}^{a} = {\sum }_{{n}_{6} = 1}^{{N}_{6}} ( Q {( {v}_{{n}_{6}}^{Y} )}^{2} - {( {t}_{{v}_{{n}_{6}}^{Y}}^{a} )}^{2} ) .$$

Step 4.6, calculate the closing degree d^{a} between the user's demand and the knowledge a, d^{a}=d₁^{a}+d₂^{a}, obtain all of the closing degree of all of the knowledge, and select some knowledge with less closing degree to fed to the user.

The present invention further provides an electronic device, including a memory and a processor. The memory is used to store programs that could support the processor to execute. Wherein the programs are programmed according to the green knowledge recommendation method.

The present invention further provides a computer readable storage medium, used to store programs that are programmed according to the green knowledge recommendation method.

Compared with the prior art, the beneficial effects of the present invention are as follows.

1. The present invention firstly divides the collected text into words, and also sets the weight to improve the usefulness of similarity calculation. The present invention secondly divides the text into two parts according to the dependency relationship between the user's demand for large type and small type, so that the user's idea is more specific and detailed, and in the demand degree model, the user's demand for different types can be combined to make the search results conform to the user's demand. According to the received knowledge, the word frequency obtained after the dictionaries and the sets, the present invention is compared with the demand function to find out the knowledge that best meets the needs of the user.

2. The present invention uses a similarity model to quickly obtain usable text. The use of demand degree model can make users combine different types of needs, so that the search results meet the needs of users. The present invention combines the demand of the user with the results of previous searches, so that the accuracy of the pushed results is greatly improved.

### BRIEF DESCRIPTION OF THE DRAWINGS

FIG. 1 is a flow diagram of the green knowledge recommendation method, according to the embodiment of the present invention.

### DETAILED DESCRIPTION OF PREFERRED EMBODIMENTS

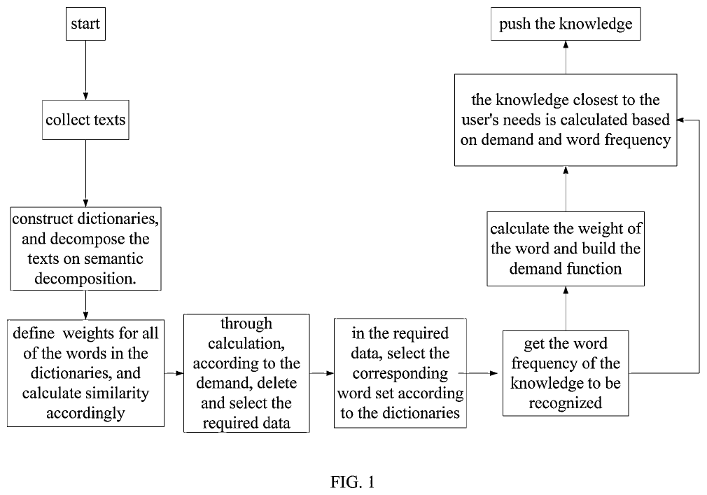

Referring to FIG. 1, in the present embodiment, a green knowledge recommendation method based on characteristic similarity and user demands includes following steps.

Step 1, obtain a current-search text e and a historical-search-texts set Eᵤ both from a user u, Eᵤ={e_{1,u}, e_{2,u} . . . , eₙ_{₁}_{,u}, . . . , e_{N}_{₁}_{,u}}. Wherein, the e_{n1,u} represents the n₁ th historical-search text, 1≤n₁≤N₁; the N₁ represents the total number of historical-search texts.

Step 2, construct a topics dictionary and a subtopics dictionary, and decompose the current-search text e and the historical-search-texts set Eᵤ on the basis of semantic decomposition. The step 2 includes steps 2.1˜2.6.

Step 2.1, construct a topics dictionary X of a green knowledge base, X={x₁, x₂, . . . , xₙ₂, . . . , x_{N2}}. Wherein the xₙ₂ represents the n₂ th topics, the N₂ represents the total number of topics in the dictionary X. The topics can be cars, machine tools, refrigerators, and other big categories.

Construct a subtopics dictionary Y of the green knowledge base, Y={y₁, y₂, . . . , yₙ₃, . . . , y_{N3}}. Wherein the yₙ₃ represents the n₃ th subtopics, the N₃ represents the total number of subtopics in the dictionary Y. The subtopics can be a small type under a large type such as a large car, bus, truck, or a component such as a chassis, engine, shell, or a lightweight, energy-saving, wear-resistant effect.

Construct a daily-expressions dictionary C of a set of users, C={c₁, c₂, . . . , cₙ₄, . . . , c_{N4}}. Wherein the cₙ₄ represents the n₄ th daily expression, the N₄ represents the total number of daily expressions in the dictionary C. The daily expression can be I, you, he, or whatever, want such everyday words.

Step 2.2, decompose e and e_{n1,u} according to dictionaries X, Y, C to obtain two text-vector sets wₑ and wₙ₁ correspondingly. The wₑ is about the current-search text e, wₑ={w₁^{e}, w₂^{e}, . . . , wᵢ_{ₑ}^{e}, . . . , wᵢ_{ₑ}^{e}}. The wₙ₁ is about the n₁ the historical-search text e_{n1,u},

$${w}_{{n}_{1}} = \{ {w}_{1}^{{n}_{1}} , {w}_{2}^{{n}_{1}} , … , {W}_{{i}_{{n}_{1}}}^{{n}_{1}} , … , {w}_{{I}_{{n}_{1}}}^{{n}_{1}} \} .$$

Wherein the wᵢ_{ₑ}^{e} represents the iₑ th word of the current-search text e; the Iₑ represents the total number of words in the current-search text e; the

$${w}_{{i}_{{n}_{1}}}^{{n}_{1}}$$

represents the i th word of the n₁ th historical-search text e_{n1,u}; the Iₙ_{₁} represents the total number of words in the n₁ th historical-search text e_{n1,u}. Here is the use of stuttering word segmentation system to carry out semantic decomposition, the use of stuttering word segmentation used the dictionaries X, Y, C. The dictionary to which the participle belongs is replaced by tᵢ_{ₑ}^{e}, and tᵢⁿ^{₁}.

Define tᵢ_{ₑ}^{e} being the label of the wᵢ_{ₑ}^{e}. If the tᵢ_{ₑ}^{e} belongs to the dictionary X, define wᵢ_{ₑ}^{e}∈X; if the tᵢ_{ₑ}^{e} belongs to the dictionary Y, define wᵢ_{ₑ}^{e}∈Y; if the tᵢ_{ₑ}^{e} belongs to the dictionary C, define wᵢ_{ₑ}^{e}∈C; otherwise define wᵢ_{ₑ}^{e}∈Ø.

Define tᵢⁿ^{₁} being the label of

$${w}_{{i}_{{n}_{1}}}^{{n}_{1}} .$$

If the tᵢⁿ^{₁} belongs to the dictionary X, define

$${w}_{{i}_{{n}_{1}}}^{{n}_{1}} ∈ X ;$$

if the tᵢⁿ^{₁} belongs to the dictionary Y, define

$${w}_{{i}_{{n}_{1}}}^{{n}_{1}} ∈$$

Y; if the tᵢⁿ^{₁} belongs to the dictionary C, define

$${w}_{{i}_{{n}_{1}}}^{{n}_{1}} ∈ C ,$$

otherwise define

$${w}_{{i}_{{n}_{1}}}^{{n}_{1}} ∈ ∅ .$$

Use labels to detect the dictionary that each word corresponds to, to simplify the identification of the relationship.

Step 2.3, obtain the weight Lᵢⁿ^{₁} of the i th word

$${w}_{{i}_{{n}_{1}}}^{{n}_{1}}$$

by the formula (1).

$${L}_{i}^{{n}_{1}} = \{ \begin{matrix}{δ}_{1} , & if {t}_{i}^{{n}_{1}} ∈ X \\ {δ}_{2} , & if {t}_{i}^{{n}_{1}} ∈ Y \\ 0 , & if {t}_{i}^{{n}_{1}} ∈ C ⋃ \{ ∅ \}\end{matrix} \qquad ( 1 )$$

In the formula, the δ₁ represents the first weight, the δ₂ represents the second weight, and 0<δ₂<δ₁<1. Set weights for words that fall under topics, subtopics, and daily-expressions.

Step 2.4, obtain the weight Lᵢ_{ₑ}^{e}, of the iₑ th word wᵢ_{ₑ}^{e} by the same way of step 2.3.

Step 2.5, obtain the similarity

$$g ( {w}_{{i}_{e}}^{e} , {w}_{{i}_{{n}_{1}}}^{{n}_{1}} )$$

between the wᵢ_{ₑ}^{e} and the

$${w}_{{i}_{{n}_{1}}}^{{n}_{1}}$$

by the formula (2).

$$\begin{matrix}( {w}_{{i}_{e}}^{e} , {w}_{{i}_{{n}_{1}}}^{{n}_{1}} ) = \\ \frac{( {\sum }_{{i}_{e} = 1}^{{I}_{e}} {w}_{{i}_{e}}^{e} {L}_{{i}_{e}}^{e} ) ( {\sum }_{{i}_{{n}_{1}} = 1}^{{I}_{{n}_{1}}} {w}_{{i}_{{n}_{1}}}^{{n}_{1}} {L}_{{i}_{{n}_{1}}}^{{n}_{1}} )}{( {{‖ {\sum }_{{i}_{e} = 1}^{{I}_{e}} {w}_{{i}_{e}}^{e} {L}_{{i}_{e}}^{e} ‖}^{2} ‖ {\sum }_{{i}_{{n}_{1}} = 1}^{{I}_{{n}_{1}}} {w}_{{i}_{{n}_{1}}}^{{n}_{1}} {L}_{{i}_{{n}_{1}}}^{{n}_{1}} ) ‖}^{2} − ( {\sum }_{{i}_{e} = 1}^{{I}_{e}} {w}_{{i}_{e}}^{e} {L}_{{i}_{e}}^{e} ) ( {\sum }_{{i}_{{n}_{1}} = 1}^{{I}_{{n}_{1}}} {w}_{{i}_{{n}_{1}}}^{{n}_{1}} {L}_{{i}_{{n}_{1}}}^{{n}_{1}} )}\end{matrix} \qquad ( 2 )$$

The text vector set is converted into a numerical vector during the computation.

Step 2.6, obtain the similarities between each of the two words respectively from two text-vector sets wₑ and wₙ₁ by the same way of step 2.5.

Collect words with the highest similarity to be a candidate-words set in which one candidate word would be select to be the n₁ th word of the wₑ.

A valid-text set Vᵢ_{ₑ}^{e} is defined by all candidate-words sets, Vᵢ_{ₑ}^{e}={v_{1,i}_{ₑ}^{e}, v_{2,i}_{ₑ}^{e}, . . . , v_{p,i}_{ₑ}^{e}, . . . , v_{P,i}_{ₑ}^{e}}.

Wherein the v_{P,i}_{ₑ}^{e} represents the p th candidate word of the iₑ th word, wᵢ_{ₑ}^{e}, the p represents the total number of candidate words. Choose the text you want based on the similarity you want.

Step 3, according to the weight, pick words in the wₑ and the Vᵢ_{ₑ}^{e} that belong to the two dictionaries X and Y. The step 3 includes steps 3.1˜3.6.

Step 3.1, pick words in the wₑ that belong to the dictionary X.

When wᵢ_{ₑ}^{e}Lᵢ_{ₑ}ⁿ^{₁}=δ₁, xᵢ_{ₑ}^{e} is defined to mean the words corresponding to the wᵢ_{ₑ}^{e} and is also from the dictionary X. The first words set is defined by many xᵢ_{ₑ}^{e} accordingly, and the Lᵢ_{ₑ}ⁿ^{₁} is the weight of the wᵢ_{ₑ}^{e}.

Step 3.2, pick words in the Vᵢ_{ₑ}^{e} that belong to the dictionary X.

When v_{p,i}_{ₑ}^{e}L_{p,i}_{ₑ}^{e}=δ₁, x_{p,i}_{ₑ}^{e} is defined to mean the words corresponding to the v_{p,i}_{ₑ}^{e} and is also from the dictionary X. The second words set is defined by many Vᵢ_{ₑ}^{e} accordingly, and the L_{p,i}_{ₑ}^{e} is the weight of the v_{p,i}_{ₑ}^{e}.

Step 3.3, a large-subject terms set Z is defined by the first words set and the second words set, Z={z₁^{X}, z₂^{X}, . . . , zₙ_{₅}^{X}, . . . , z_{N}_{₅}^{X}}. Wherein the zₙ_{₅}^{X} represents the n₅ th large-subject term, 1≤n₅≤N₅, and the N₅ represents the total number of large-subject terms. The number of the large-subject terms is set to prepare the text content for the demand for words of a topic and the closeness of knowledge to the topic.

Step 3.4, pick words in the wₑ that belong to the dictionary Y. When wᵢ_{ₑ}^{e}Lᵢⁿ^{₁}=δ₁, γᵢ_{ₑ}^{e} is defined to mean the words corresponding to the wᵢ_{ₑ}^{e} and is also from the dictionary Y.

Step 3.5, pick words in the Vᵢ_{ₑ}^{e} that belong to the dictionary Y; when Lᵢⁿ^{₁}=δ₁, γᵢ^{valid} is defined to mean the words corresponding to the Vᵢ_{ₑ}^{e} and is also from the dictionary Y.

Step 3.6, a minor-subject terms set V is defined by the wₑ and the Vᵢ_{ₑ}^{e}, V={v₁^{Y}, v₂^{Y}, . . . , vₙ₆^{Y}, . . . v_{N6}^{Y}}. Wherein the vₙ₆^{Y}, represents the n₆ th minor-subject term, 1≤n₆≤N₆, and the No represents the total number of minor-subject terms. The number of the minor-subject terms is set to prepare the text content for the demand for words of a subtopic and the closeness of knowledge to the subtopic.

Step 4, find the corresponding knowledge according to user satisfaction. The step 4 includes steps 4.1˜4.6.

Step 4.1, acquire a knowledge a to be identified, and calculate the frequency of each of the word appearing in the knowledge a after semantic decomposition under the dictionary X and the minor-subject terms set V,

$$\{ {s}_{{x}_{1}}^{a} , … {s}_{{x}_{{n}_{2}}}^{a} , … {s}_{{x}_{{N}_{2}}}^{a} , {t}_{{v}_{1}^{Y}}^{a} , … , {t}_{{v}_{{n}_{6}}^{Y}}^{a} , … , {t}_{{v}_{{N}_{6}}^{Y}}^{a} \} .$$

### Wherein the

$${s}_{{x}_{{n}_{2}}}^{a}$$

represents the frequency of the n₂ th topic xₙ_{₂} appearing in the knowledge a,

$$0 \leq {s}_{{x}_{{n}_{2}}}^{a} \leq 1 ;$$

and the

$${t}_{{v}_{{N}_{6}}^{Y}}^{a}$$

represents the frequency of the n₆ th subtopic vₙ₆^{Y} appearing in the knowledge a, 0≤

$${t}_{{v}_{{n}_{6}}^{Y}}^{a} \leq 1 .$$

Step 4.2, assigns a value to each of the word in the minor-subject terms set V, and a weighting function H(vₙ₆^{Y}) of words in minor-subject terms set V is defined as formula (3). Here, word frequency is used to show the proportion of each feature in the knowledge a, and it is also the influence of each feature in the knowledge a.

$$H ( {v}_{{n}_{6}}^{Y} ) = \frac{{v}_{{n}_{6}}^{Y}}{{\sum }_{{n}_{6} = 1}^{{N}_{6}} {v}_{{n}_{6}}^{Y}} \qquad ( 3 )$$

Step 4.3, a user-demand degree function Q(vₙ₆^{Y}) is defined as formula (4).

$$Q ( {v}_{{n}_{6}}^{Y} ) = H ( {v}_{{n}_{6}}^{Y} ) k \qquad ( 4 )$$

In the formula, the K represents users' satisfaction, kϵ(0,100%).

Because there are some effects in the user's overall text that are more searched, this is obviously what the user wants more.

Step 4.4, get a topic xᵤₛₑᵣ required by the user in the topics dictionary X, and calculate the closing degree d^{a} between the topic xᵤₛₑᵣ and the knowledge a, d₁^{a}=1−sₓ_{ᵤₛₑᵣ}^{a}. Wherein the sₓ_{ᵤₛₑᵣ}^{a} represents the frequency of the topic xᵤₛₑᵣ appearing in the knowledge a. Because there is usually only one requirement for a car or airplane, for example, set the header requirement to 1.

Step 4.5, get the user's demand for each of the minor-subject term in the minor-subject terms set V, and calculate the user's closing degree d₂^{a} to all of the minor-subject terms,

$${d}_{2}^{a} = {\sum }_{{n}_{6} = 1}^{{N}_{6}} ( Q {( {v}_{{n}_{6}}^{Y} )}^{2} - {( {t}_{{v}_{{n}_{6}}^{Y}}^{a} )}^{2} ) .$$

Because the semantic decomposition uses the minor-subject terms set V, the subscript of vₙ₆^{Y} is n₆.

Step 4.6, calculate the closing degree d^{a} between the user's demand and the knowledge a, d^{a}=d₁^{a}+d₂^{a}, obtain all of the closing degree of all of the knowledge, and select some knowledge with less closing degree to fed to the user.

The present embodiment further provides an electronic device, including a memory and a processor. The memory is used to store programs that could support the processor to execute. Wherein the programs are programmed according to the green knowledge recommendation method.

The present embodiment further provides a computer readable storage medium, used to store programs that are programmed according to the green knowledge recommendation method.

What is claimed is:

1. A green knowledge recommendation method based on characteristic similarity and user demands, comprises:
step 1, obtaining a current-search text e and a historical-search-texts set Eᵤ both from a user u, Eᵤ={e_{1,u}, e_{2,u} . . . , eₙ_{₁}_{,u}, . . . , e_{N}_{₁}_{,u}}, wherein, the eₙ_{₁}_{,u} represents the n₁ the historical-search text, 1≤n₁≤N₁; the N₁ represents the total number of historical-search texts;
step 2, constructing a topics dictionary and a subtopics dictionary, and decomposing the current-search text e and the historical-search-texts set Eᵤ on the basis of semantic decomposition; the step 2 comprising steps 2.1˜2.6;
step 2.1, constructing a topics dictionary X of a green knowledge base, X={x₁, x₂, . . . , xₙ₂, . . . , x_{N}_{₂}}, wherein the xₙ₂ represents the n₂ th topics, the N₂ represents the total number of topics in the dictionary X;
constructing a subtopics dictionary Y of the green knowledge base, Y={y₁, y₂, . . . , yₙ₃, . . . , y_{N3}}, wherein the yₙ₃ represents the n₃ th subtopics, the N₃ represents the total number of subtopics in the dictionary Y;
constructing a daily-expressions dictionary C of a set of users, C={c₁, c₂, . . . , cₙ₄, . . . , c_{N4}}, wherein the cₙ₄ represents the n₄ th daily expression, the N₄ represents the total number of daily expressions in the dictionary C;
step 2.2, decomposing e and eₙ_{₁}_{,u} according to dictionaries X, Y, C to obtain two text-vector sets wₑ and wₙ_{₁} correspondingly; the wₑ being about the current-search text e, wₑ={w₁^{e}, w₂^{e}, . . . , wᵢ_{ₑ}^{e}, . . . , wₗ_{ₑ}^{e}}, the wₙ₁ being about the 11 th historical-search text eₙ_{₁}_{,u},
$${w}_{{n}_{1}} = \{ {w}_{1}^{{n}_{1}} , {w}_{2}^{{n}_{1}} , … , {w}_{{i}_{{n}_{1}}}^{{n}_{1}} , … , {w}_{{I}_{{n}_{1}}}^{{n}_{1}} \} ;$$
wherein the wᵢ_{ₑ}^{e} represents the iₑ th word of the current-search text e, the Iₑ represents the total number of words in the current-search text e, the wᵢ_{ₙ}₁ⁿ^{₁} represents the i th word of the n₁ th historical-search text eₙ_{₁}_{,u}, the Iₙ_{₁} represents the total number of words in the n₁ th historical-search text eₙ_{₁}_{,u};
defining tᵢ_{ₑ}^{e} being the label of the wᵢ_{ₑ}^{e}; if the tᵢ_{ₑ}^{e} belonging to the dictionary X, defining wᵢ_{ₑ}^{e}∈X; if the tᵢ_{ₑ}^{e} belonging to the dictionary Y, defining wᵢ_{ₑ}^{e}∈Y; if the tᵢ_{ₑ}^{e} belonging to the dictionary C, defining wᵢ_{ₑ}^{e}∈C; otherwise defining wᵢ_{ₑ}^{e}∈Ø;
defining tᵢⁿ^{₁} being the label of
$${w}_{{i}_{{n}_{1}}}^{{n}_{1}} ;$$
if the tᵢⁿ^{₁} belonging to wₑ dictionary X, defining
$${w}_{{i}_{{n}_{1}}}^{{n}_{1}} ∈ X ;$$
if the tᵢⁿ^{₁} belonging to the dictionary Y, defining
$${w}_{{i}_{{n}_{1}}}^{{n}_{1}} ∈ Y ;$$
if the tᵢⁿ^{₁} belonging to the dictionary C, defining
$${w}_{{i}_{{n}_{1}}}^{{n}_{1}} ∈ C ;$$
otherwise defining
$${w}_{{i}_{{n}_{1}}}^{{n}_{1}} ∈ ∅ ;$$
step 2.3, obtaining the weight Lᵢⁿ^{₁} of the i th word
$${w}_{{i}_{{n}_{1}}}^{{n}_{1}}$$
by the formula (1):
$${L}_{i}^{{n}_{1}} = \{ \begin{matrix}{δ}_{1} , & if {t}_{i}^{{n}_{1}} ∈ X \\ {δ}_{2} , & if {t}_{i}^{{n}_{1}} ∈ Y \\ 0 , & if {t}_{i}^{{n}_{1}} ∈ C ⋃ \{ ∅ \}\end{matrix} \qquad ( 1 )$$
in the formula, the δ₁ representing the first weight, the δ₂ representing the second weight, 0<δ₂<δ₁<1;
step 2.4, obtaining the weight Lᵢ_{ₑ}^{e} of the iₑ th word wᵢ_{ₑ}^{e} by the same way of step 2.3;
step 2.5, obtaining the similarity
$$g ( {w}_{{i}_{e}}^{e} , {w}_{{i}_{{n}_{1}}}^{{n}_{1}} )$$
between the wᵢ_{ₑ}^{e} and the
$${w}_{{i}_{{n}_{1}}}^{{n}_{1}}$$
by the formula (2);
$$( 2 )$$
$$g ( {w}_{{i}_{e}}^{e} , {w}_{{i}_{{n}_{1}}}^{{n}_{1}} ) = \frac{( {\sum }_{{i}_{e}}^{{I}_{e}} {w}_{{i}_{e}}^{e} {L}_{{i}_{e}}^{e} ) ( {\sum }_{{i}_{{n}_{1}} = 1}^{{I}_{{n}_{1}}} {w}_{{i}_{{n}_{1}}}^{{n}_{1}} {L}_{{i}_{{n}_{1}}}^{{n}_{1}} )}{{‖ {\sum }_{{i}_{e} = 1}^{{I}_{e}} {w}_{{i}_{e}}^{e} {L}_{{i}_{e}}^{e} ‖}^{2} {‖ {\sum }_{{i}_{{n}_{1}} = 1}^{{I}_{{n}_{1}}} {w}_{{i}_{{n}_{1}}}^{{n}_{1}} {L}_{{i}_{{n}_{1}}}^{{n}_{1}} ‖}^{2} − ( {\sum }_{{i}_{e} = 1}^{{I}_{e}} {w}_{{i}_{e}}^{e} {L}_{{i}_{e}}^{e} ) ( {\sum }_{{i}_{{n}_{1}} = 1}^{{I}_{{n}_{1}}} {w}_{{i}_{{n}_{1}}}^{{n}_{1}} {L}_{{i}_{{n}_{1}}}^{{n}_{1}} )}$$
step 2.6, obtaining the similarities between each of the two words respectively from two text-vector sets wₑ and wₙ₁ by the same way of step 2.5, and collecting words with the highest similarity to be a candidate-words set in which one candidate word would be select to be the n₁ th word of the wₑ; a valid-text set Vᵢ_{ₑ}^{e} being defined by all candidate-words sets, Vᵢ_{ₑ}^{e}={v_{1,i}_{ₑ}^{e}, v_{2,i}_{ₑ}^{e}, . . . , v_{p,i}_{ₑ}^{e}, . . . , v_{P,i}_{ₑ}^{e}}, wherein the v_{P,i}_{ₑ}^{e} represents the p th candidate word of the iₑ th word wᵢ_{ₑ}^{e}, the p represents the total number of candidate words;
step 3, according to the weight, picking words in the wₑ and the Vᵢ_{ₑ}^{e} that belong to the two dictionaries X and Y; the step 3 comprising steps 3.1˜3.6;
step 3.1, picking words in the wₑ that belong to the dictionary X;
when wᵢ_{ₑ}^{e}Lᵢ_{ₑ}ⁿ^{₁}=δ₁, xᵢ_{ₑ}^{e} defined to mean the words corresponding to the wᵢ_{ₑ}^{e} and also from the dictionary X, and the first words set defined by many xᵢ_{ₑ}^{e} accordingly; the Lᵢ_{ₑ}ⁿ^{₁} being the weight of wᵢ_{ₑ}^{e};
step 3.2, picking words in the Vᵢ_{ₑ}^{e} that belong to the dictionary X;
when v_{p,i}_{ₑ}^{e}L_{p,i}_{ₑ}^{e}=δ₁, x_{p,i}_{ₑ}^{e} defined to mean the words corresponding to the voice and also from the dictionary X, and the second words set defined by many Vᵢ_{ₑ}^{e} accordingly; the L_{p,i}_{ₑ}^{e} being the weight of the v_{p,i}_{ₑ}^{e};
step 3.3, a large-subject terms set Z defined by the first words set and the second words set, Z={z₁^{X}, z₂^{X}, . . . , zₙ_{₅}^{X}, . . . , z_{N}_{₅}^{X}}, wherein the Zₙ_{₅}^{X} represents the n₅ th large-subject term, 1≤n₅≤N₅, and the N₅ represents the total number of large-subject terms;
step 3.4, picking words in the wₑ that belong to the dictionary Y; when wᵢ_{ₑ}^{e}Lᵢⁿ^{₁}=δ₁, γᵢ_{ₑ}^{e} defined to mean the words corresponding to the wᵢ_{ₑ}^{e} and also from the dictionary Y;
step 3.5, picking words in the Vᵢ_{ₑ}^{e} that belong to the dictionary Y; when Lᵢⁿ^{₁}=δ₁, yᵢ^{valid} defined to mean the words corresponding to the Vᵢ_{ₑ}^{e} and also from the dictionary Y;
step 3.6, a minor-subject terms set V defined by the wₑ and the Vᵢ_{ₑ}^{e}, V={v₁^{Y}, v₂^{Y}, . . . , vₙ_{₆}^{Y}, . . . , v_{N}_{₆}^{Y}}, wherein the vₙ_{₆}^{Y} represents the n₆ th minor-subject term, 1≤n₆≤N₆, and the No represents the total number of minor-subject terms;
step 4, finding the corresponding knowledge according to user satisfaction; the step 4 comprising steps 4.1˜4.6;
step 4.1, acquiring a knowledge a to be identified, and calculating the frequency of each of the word appearing in the knowledge a after semantic decomposition under the dictionary X and the minor-subject terms set V,
$$\{ {s}_{{x}_{1}}^{a} , … {s}_{{x}_{{n}_{2}}}^{a} , … {s}_{{x}_{{N}_{2}}}^{a} , {t}_{{v}_{1}^{Y}}^{a} , … , {t}_{{v}_{{n}_{6}}^{Y}}^{a} , … , {t}_{{v}_{{N}_{6}}^{Y}}^{a} \} ,$$
wherein the
$${s}_{{x}_{{n}_{2}}}^{a}$$
represents the frequency of the n₂ th topic xₙ_{₂} appearing in the knowledge a,
$$0 \leq {s}_{{x}_{{n}_{2}}}^{a} \leq 1 ;$$
and the
$${t}_{{v}_{{N}_{6}}^{Y}}^{a}$$
represents the frequency of the n₆ the subtopic vₙ_{₆}^{Y} appearing in the knowledge a,
$${t}_{{v}_{{n}_{6}}^{Y}}^{a} \leq 1 ;$$
step 4.2, assigning a value to each of the word in the minor-subject terms set V, and a weighting function H(vₙ_{₆}^{Y}) of words in minor-subject terms set V being defined as formula (3);
$$H ( {v}_{{n}_{6}}^{Y} ) = \frac{{v}_{{n}_{6}}^{Y}}{{\sum }_{{n}_{6} = 1}^{{N}_{6}} {v}_{{n}_{6}}^{Y}} \qquad ( 3 )$$
step 4.3, a user-demand degree function Q(vₙ_{₆}^{Y}) being defined as formula (4);
$$Q ( {v}_{{n}_{6}}^{Y} ) = H ( {v}_{{n}_{6}}^{Y} ) k \qquad ( 4 )$$
in the formula, the K representing users' satisfaction, kϵ(0,100%);
step 4.4, getting a topic xᵤₛₑᵣ required by the user in the topics dictionary X, and calculating the closing degree d₁^{a} between the topic xᵤₛₑᵣ and the knowledge a, d₁^{a}=1−sₓ_{ᵤₛₑᵣ}^{a}, wherein the sₓ_{ᵤₛₑᵣ}^{a} represents the frequency of the topic xᵤₛₑᵣ appearing in the knowledge a;
step 4.5, getting the user's demand for each of the minor-subject term in the minor-subject terms set V, and calculating the user's closing degree dg to all of the minor-subject terms,
$${d}_{2}^{a} = {\sum }_{{n}_{6} = 1}^{{N}_{6}} ( Q {( {v}_{{n}_{6}}^{Y} )}^{2} - {( {t}_{{v}_{{n}_{6}}^{Y}}^{a} )}^{2} ) ;$$
step 4.6, calculating the closing degree d^{a} between the user's demand and the knowledge a, d^{a}=d₁^{a}+d₂^{a}, obtaining all of the closing degree of all of the knowledge, and selecting some knowledge with less closing degree to fed to the user.

2. An electronic device, comprising a memory and a processor, the memory used to store programs that could support the processor to execute, wherein the programs are programmed according to claim 1.

3. A computer readable storage medium, used to store programs that are programmed according to claim 1.
